(19) United States
(12) Patent Application Publication
(10) Pub. No.: US 2006/0028491 A1
(43) Pub. Date: Feb. 9, 2006

(54) System and method for providing a protable printer capable of altering the orientation of information displayed on an associated printer display

(75) Inventor: Craig Horrocks, Narragansett, RI (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: ZIH Corp.

(21) Appl. No.: 11/192,973

(22) Filed: Jul. 29, 2005

Related U.S. Application Data
(60) Provisional application No. 60/592,490, filed on Jul. 29, 2004.

(51) Int. Cl. G09G 5/00

(52) U.S. Cl. 345/649

(57) ABSTRACT

Systems and methods are described that allow a user to set the orientation of characters to be displayed on a display based on the orientation of the printer. If the printer is positioned in a right side up orientation, the characters are displayed in a right side up manner. If the printer is in another orientation, such as upside down, the systems “flip” the characters so that the user can read the display. Each character is typically stored in a bitmap comprising a matrix pixels aligned in rows and columns. The systems display the characters by incrementing through each column and displaying the pixels in the column. When the character is to be displayed in an upside down manner, the systems read the columns from the bit map out in reverse order. For each column, the systems flip each pixels to thereby flip the character displayed.

### CROSS-REFERENCE TO RELATED APPLICATIONS

The present application claims priority from U.S. Provisional Application Ser. No. 60/592,490; Filed Jul. 29, 2004; and entitled SYSTEM AND METHOD FOR PROVIDING A PORTABLE PRINTER CAPABLE OF ALTERING THE ORIENTATION OF INFORMATION DISPLAYED ON AN ASSOCIATED PRINTER DISPLAY, the contents of which are incorporated herein by reference.

### BACKGROUND OF THE INVENTION

1. Field of the Invention

The present invention is related to the display of information on a portable printer and more particularly to a portable printer capable of altering the orientation of the information displayed on a display associated with the portable printer.

2. Description of Related Art

Many advances in printer technology have been made since printers were introduced into the workplace. The first generation of printers did not provide status information related to printer operation. Delays resulted from trying to diagnose the various problems, which included paper jams, a lack of paper in the printing tray, or an improper communication between the instructing computer and the printer.

Many modern desktop printers use displays such as liquid crystal displays (LCDs) that tell the user if there is a specific problem with the printer. For example, many modern printers now indicate if there is a paper jam or a lack of paper in a printing tray. They will also display more general information, such as indicating which tray the paper is being taken from when the printer is in use.

The introduction of portable printers has revolutionized printing. Portable printers are generally more rugged than desktop printers, and they are obviously much more mobile. Because they are handheld, they are also easily accessible. Portable printers are typically used for such applications as point-of-transaction processing, shelf labeling, price marking, bin labeling, product identification, receipt printing, route accounting/field service, event and passenger ticketing, gaming transactions, and parking tickets and violations.

Another benefit of portable printers is the new concept of docking portable printers into docking stations so that they remain stationary for either travel or use such as is described in U.S. patent application Ser. No. 10/901,637, filed Jul. 29, 2004, and, titled DOCKING STATION AND ASSOCIATED METHOD FOR DOCKING A PORTABLE PRINTER to Lyman et al. This aspect of the invention is useful in several different situations. In order to take inventory or monitor the activity, companies can require their employees to dock their portable printers and upload certain useful information into a company computer. Portable printers can also be docked by delivery drivers on the inside of their cars, possibly on the top or bottom of the dashboard.

Problems such as poor lighting and changing orientations will often arise given the nature of the uses of portable printers. These uses also require that the display screen be easily visible in order to make the printing process as easy and efficient as possible. If the printer is docked on the bottom of a vehicle's dashboard, the reader may be forced to read the display screen while the characters are upside down, which is difficult.

Therefore, it would be advantageous to have a portable printer with a display that is adaptable to the various situations encountered during mobile use. In particular, it would be advantageous to have a portable printer with a display that promotes easy visibility in conditions encountered during mobile and dynamic use.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a printer of one embodiment of the present invention;

FIG. 2 is a perspective view of the printer of FIG. 1 with a media cover in an open position;

FIG. 3 is a perspective view of a wireless card processor cover and main circuit board of the printer of FIG. 1;

FIG. 4 is a perspective view of contents of a base portion of the printer of FIG. 1;

FIG. 5 is an exploded view of a print head, drive and latching assemblies of the printer of FIG. 1;

FIG. 6 is a perspective view of a media support assembly of the printer of FIG. 1;

FIG. 7 is a perspective view of the media support assembly of FIG. 6;

FIG. 8 is another perspective view of the media support assembly of FIG. 6 containing a roll of media;

FIG. 9 is an exploded view of the media support assembly of FIG. 6;

FIG. 10 is a perspective view of the print head assembly of FIG. 5;

FIG. 11 is a sectional view of the print head assembly of FIG. 5;

FIG. 12 is a perspective view of an interrupt sensor mounted on the main circuit board and a latch member of the printer of FIG. 1;

FIG. 13 is a partial view of a latch assembly of the printer of FIG. 1;

FIG. 14 is a perspective view of the print head assembly of FIG. 5 and the latch assembly of FIG. 13; and

FIG. 15 is an elevation view of the latch member of FIG. 12.

FIGS. 16a and 16b are respective illustrations of the printer of FIG. 1 in both an upright and upside down orientation, whereby the text is displayed in a manner that is readable to an observer according to one embodiment of the present invention.

FIG. 17a is an illustration of the display of printer illustrating the character fields available for printing.

FIGS. 17b and 17c are respective illustrations of a character bit map in an upright and upside down orientation.

FIGS. 18 and 19 are flow diagrams illustrating operations for displaying characters on the display in different orientations according to one embodiment of the present invention.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be discussed later below, the present invention provides systems and methods for orienting characters in the display of a portable printer. Specifically, systems and methods are provided that allow a user to set in which orientation the characters are displayed based on the orientation of the printer. If the printer is positioned in a right side up orientation, the characters on the display will be displayed in a right side up manner. However, if the printer is in another orientation, such as upside down, the systems and methods “flip” the characters so that the user can read the display.

Each character is typically stored in a bitmap made up of a matrix pixels aligned in rows and columns. The systems and methods display the characters by incrementing through each column and displaying the pixels in the column. When the character is to be displayed in an upright manner, the systems and methods begin in top left corner of the display and systematically read out and display each column of the bit map for the character. However, if the character is flipped, the systems and methods go to bottom right corner of the display and read the columns from the bit map out in reverse order. For each column, the systems and methods flips each pixels to thereby flip the character displayed.

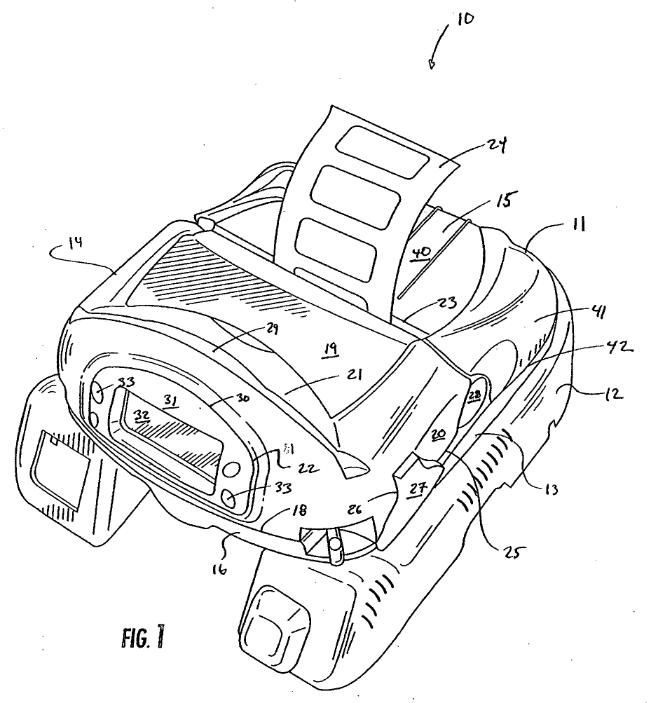

Various aspects of the printer illustrated in FIG. 1 are described in greater detail in the following patent applications which have been filed concurrently herewith and are hereby incorporated herein in their entirety by reference, including:

U.S. Provisional Application No. 60/592,110 to Klein, et al., filed on Jul. 29, 2004 and entitled INTERCHANGEABLE MODULE FOR A PORTABLE PRINTER AND SYSTEM FOR OPERATING THE SAME;

U.S. Nonprovisional application Ser. No. 10/901,883 to Lyman, et al., filed on Jul. 29, 2004 and entitled PRINTER ASSEMBLY AND METHOD OF USING THE SAME;

U.S. Nonprovisional application Ser. No. 10/901,637 to Lyman, et al., filed on Jul. 29, 2004 and entitled DOCKING STATION AND ASSOCIATED METHOD FOR DOCKING A PORTABLE PRINTER;

U.S. Nonprovisional application Ser. No. 10/901,718 to Beck, et al., filed on Jul. 29, 2004 and entitled UNIVERSAL CARD READER APPARATUS AND METHOD; and

U.S. Nonprovisional application Ser. No. 10/901,686 to Beck, et al., filed on Jul. 29, 2004 and entitled PRINTER CABLE AND ASSOCIATED STRAIN RELIEF COLLAR FOR CREATING A RUGGEDIZED CONNECTION FOR AN ELECTRICAL TERMINAL OF A PRINTER AND ASSOCIATED METHODS THEREFOR.

A handheld printer 10 of one embodiment of the present invention is shown in FIGS. 1-14. Generally, the printer includes a rounded, rectangular housing 11 that can be supported within a cradle 12, as shown in FIG. 1. The housing has three main sub-portions, including a base 13, a modular component cover 14 and a media supply lid or cover 15.

The base 13 has a rectangular shape with a wall structure 16 extending upwards from a bottom surface 17 to support and contain various electronic and mechanical assemblies of the printer 10. The wall structure 16 ends in a free edge 18 that extends continuously around the rectangular shape of the base 13 and is configured to mate with the card processor cover 14 and the media supply cover 15.

The modular component cover 14 includes a deck portion 19, a pair of sidewalls 20, an information card receiving portion 21 and a display portion 22. The deck portion 19 is a relatively planar surface that extends between the pair of sidewalls 20 and defines one edge of a media dispensing opening 23 through which a strip of media 24 extends, as shown in FIG. 1. Each of the sidewalls 20 includes a free edge that is configured to mate with the media supply cover 15 and with the free edge 18 of the base wall structure 16. A portion of the free edge of one of the sidewalls 20 has an arc shape to provide clearance (along with an arc shape defined by the media supply cover 15 and a semi-circle defined by the free edge 18 of the base wall structure 16) for a latch button 28 used to open the media supply cover 15.

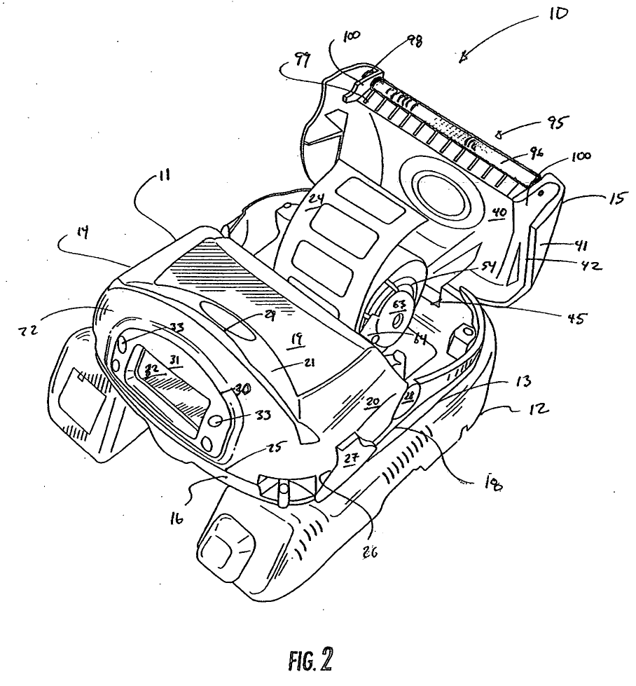

Abutting the deck portion 19 is the information card receiving portion 21, as shown in FIGS. 1-2. The information card receiving portion 21 extends upwardly to a peak and downwardly transitioning into the display portion 22. Defined at the peak of the information card receiving portion 21 is a card receiving slot 29 that is sized and shaped to allow a magnetic strip information card (such as a credit card) to be “swiped” therethrough for reading and decoding of information recorded thereon.

Other types of information card could also be extended through the card receiving slot 29 for reading, including various bar-coded cards or contact and non-contact smart cards. Further, any media, such as envelope, slip of paper, etc., having a magnetic strip or smart card features could be slid and read via the slot. The display portion 22 of the card processor cover 14 defines a display opening 30 through which extends a display unit 31, as shown in FIGS. 1 and 2. The display unit 31 includes a display screen 32 and four buttons 33 that communicate information on operation of the printer 10 and record inputs and selections by the operator.

The media supply cover 15 includes its own deck portion 41 and wall structure 42, as shown in FIGS. 1 and 2. The deck portion 41 is a relatively flat, planar surface that is coextensive with the deck portion 19 of the modular component cover 14. The deck portion 41 defines an edge of the media dispensing opening 23 opposite the edge defined by the deck portion 19 of the modular component cover 14. Optionally, the deck portion may be constructed of a transparent or translucent material to facilitate visibility of the media roll in anticipation of replacement of a spent or nearly spent media roll. A free edge of the wall structure 42 is configured to mate with a portion of the free edge of the sidewalls 20 of the modular component cover 14 and a portion of the free edge 18 of the wall structure 16 of the base 13 to form the closed housing 11 shown in FIG. 1.

Now that the external aspects of the printer 10 of the illustrated embodiment have been described, including the structure of its housing 11, attention will be turned to the contents of the housing, including the various assemblies that enable the printing and card reading functions.

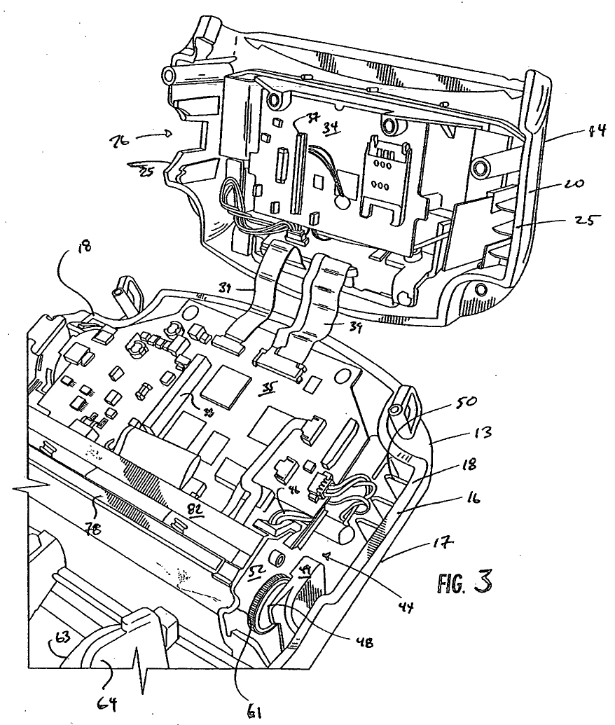

Supported by the wireless card processor cover 14 is a wireless communications and card processing circuit board 34, as shown in FIG. 3. The circuit board 34 is configured to perform communications tasks and includes, for example, one or more of a Wi-Fi 802.11 wireless interface, a Bluetooth wireless radio and a cellular network connection to promote wireless, handheld use. The wireless communications and card processing circuit board 34 is further configured to interface with a smartcard, magnetic card, barcode scanning or other information card reading device (not shown) supported in the wireless card processor cover 14 between the cover and the circuit board 34.

Generally, the wireless communications and card processing circuit board 34 obtains information from the card reading device, processes the data and routes it to a main circuit board 35. Supported on the wireless communications and card processing circuit board 34 is a multiple pin male connector 37 that is configured for insertion into a multiple pin female connector 38 on the main circuit board 35 when the housing 11 is assembled, thereby enabling the aforementioned communication between the two boards. The display unit 31 is also supported by the wireless card processor cover 14 and is connected to the main circuit board 35 by ribbon cables 39 allowing communication between the display unit and the main circuit board.

Hereagain the above description of the wireless card processor cover 14 is somewhat specific to a card reading module. In other embodiments, not shown, the module can be an optical scanner, RF receiver/transmitter, RFID tag encoder/decoder, etc., in which case different components in the module would be used to facilitate its use and communication with the main circuit board 35 of the base 12 described below.

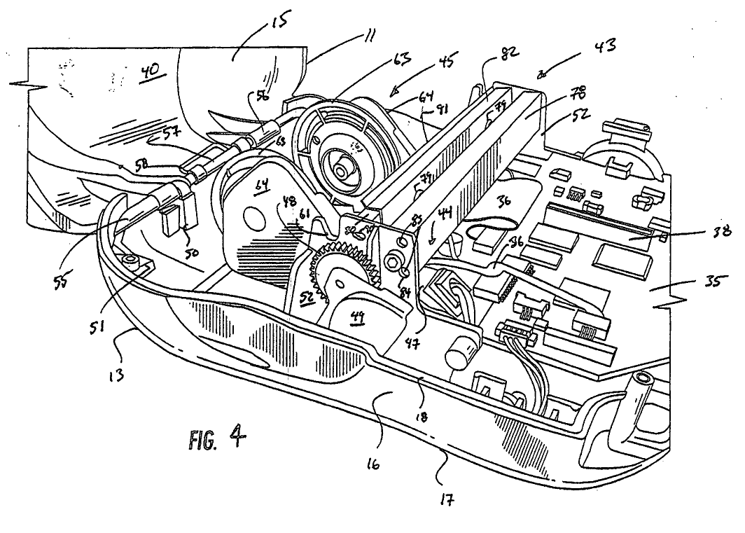

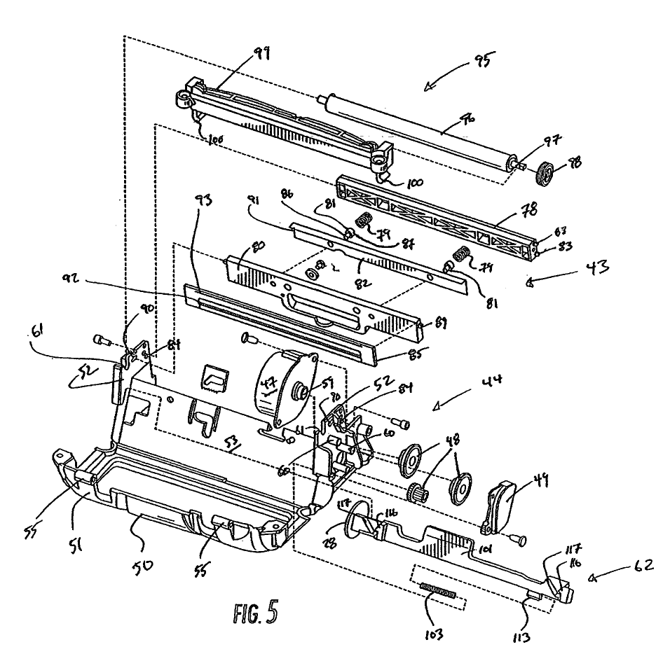

Referring now to FIG. 4, the base 13 of the housing 11 supports the main circuit board 35, a print head assembly 43, a drive assembly 44, a media support assembly 45 and a latch assembly 62. The print head assembly 43, the drive assembly 44, the media support assembly 45 and the latch assembly 62 are each mounted on a frame 50, as shown in FIGS. 4 and 5.

The frame 50 is supported within, and attached to, the base 13 of the housing 11. The frame 50 includes a hinge portion 51, and one or more side flanges 52 and a divider wall 53. The hinge portion 51 typically has a rectangular frame shape with rounded edges so as to fit in the rounded shape in an area of the base 13 housing a media supply roll 54. One or more hinge mounts 55 of the hinge portion 51 are positioned to extend along the free edge 18 of the base wall structure and to allow rotatable mounting of the media supply cover 15 at one edge via its own hinge mounts 56. A shaft 57 extends through the mounts 55, 56 and has mounted thereon a torsion spring 58 which biases the media supply cover 15 into its open position, as shown in FIG. 4.

It should be noted that the second stage opening device could also include other opening mechanisms such as a solenoid, pneumatics, hydraulics or other biasing devices and still fall within the purview of the present invention. The illustrated torsion spring, however, does have the advantage of a light weight and relatively low cost, especially since it is assisted in its first, or initial stage of opening by the latching mechanism.

The side flanges 52 of the frame 50 extend upwards from the base 13 of the housing 11 on the lateral sides of the base. The divider wall 53 extends between the side flanges 52 and generally partitions the base 13 into two portions, one portion having the media support assembly 45 and the other portion containing the main circuit board 35. Both the flanges 52 and the divider wall 53 have structure that provides support for the assemblies 43, 44 and 45, as will be described in more detail below with the description of the assemblies.

The main circuit board 35 includes a processor and other electronic components for controlling printer operation which are not described in greater detail herein for the sake of brevity. A pigtail wire 46 connects the main circuit board 35 to the drive assembly 44 and ribbon cables 36 connect the main circuit board to the print head assembly 43. As mentioned above, the ribbon cables 39 connect the display unit 31 to the main circuit board. These connections enable the main circuit board 35 to communicate with, and control, the print head and drive assemblies 43, 44.

The drive assembly 44 includes a motor 47, several drive gears 48 and a gear cover 49, as shown in FIGS. 4 and 5. The motor 47 is mounted to the inside surface of one of the side flanges 52 and has a drive shaft 59 extending through an opening in the side flange to mesh with the drive gears 48. The drive gears are rotatably mounted on pegs 60 extending from the opposite side of the side flange, and mesh with each other so as to be driven by the motor 47. The gear cover 49 is mounted over a portion of the drive gears 48 so as to protect the drive gears during operation.

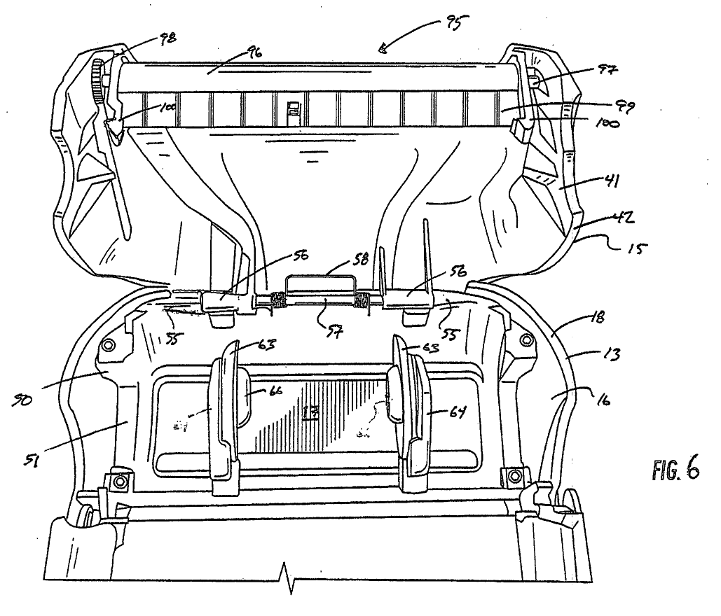

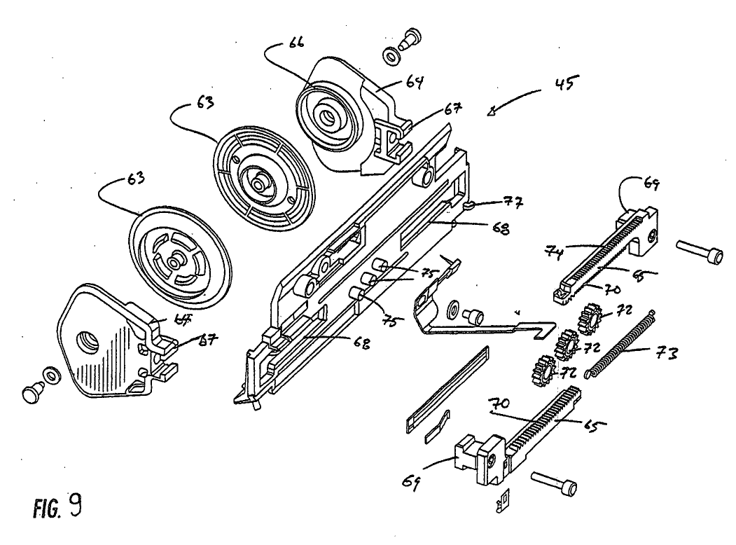

The media support assembly 45 includes a pair of media support discs 63, a pair of disc support flanges 64, a pair of racks 65, two or more pinions 72 and a tension spring 73, as shown in FIGS. 6-9. Each of the media support discs 63 has circular outer edges and a centrally located raised circular portion configured to grip an end of the media supply roll 54, as shown in FIG. 6. The media support discs 63 are supported by the disc support flanges 64 in opposing positions so as to be able to grip the media supply roll 54 when positioned between the media support discs. As shown in FIG. 9, each of the disc support flanges has a circular mounting 66 configured to allow free rotation of the media support discs 63. In addition, each of the disc support flanges 64 also includes a mount 67 that has an internal channel shape that is configured to mate with a T-shaped mounting 69 fixed to a respective one of the racks 65.

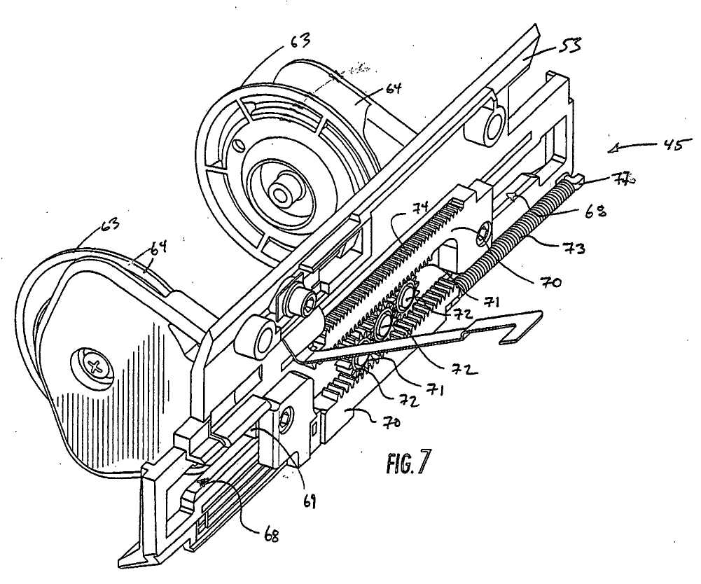

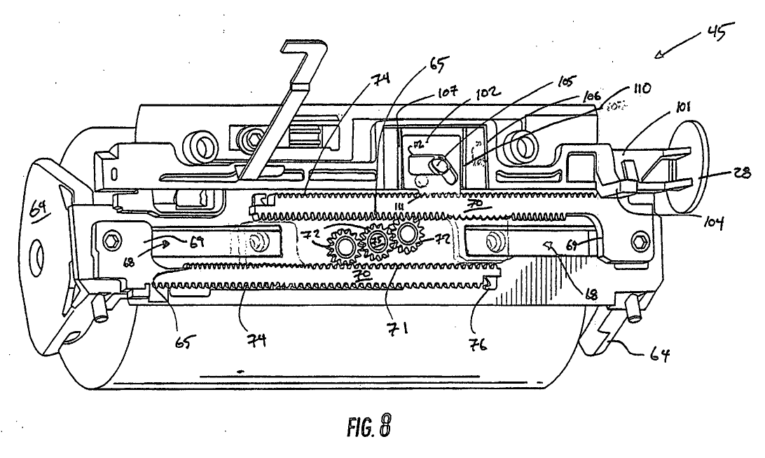

The T-shaped mounting 69 of each of the racks 65 is also configured to fit and slide within a respective one of a pair of guide slots 68 defined by the divider wall 53, as shown in FIGS. 7 and 8. Extending from the T-shaped mounting 69 is a rack arm 70 that has a pinion face 71 that has teeth shaped to mesh with the teeth of one of the pinions 72. The rack arm 70 also includes a locking face 74 positioned opposite the pinion face 71 for interacting with the latch assembly 62 to lock the rack arm in place, as will be described in more detail below.

One rack arm 70 occupies a lower position below the pinions 72 and extends in an opposite direction from the other rack arm which is positioned above the pinions. The pinions 72 are each rotatably mounted on pinion pegs 75 (shown in FIG. 9) extending outwardly from the divider wall 53 and communicate sliding motion between the rack arm 70 of each of racks 65. Each of the racks 65 also includes a spring hook 76 formed at an end opposite the T-shaped mounting 69. Attached to the spring hook 76 of one, or both, of the racks 65 is the tension spring 73 that extends therefrom to an attachment hook 77 formed on the divider wall 53.

The tension spring 73 biases the disc support flanges 64 and media support discs 63 together by exerting tension directly on its one of the racks 65, and indirectly on the other one of the racks through the pinions 72. As shown in FIG. 7, the length of the guide slots of 53 acts as a stop against the racks 65 running into each other and limits the travel of the media support discs 63. This facilitates one-handed insertion of the media supply roll 54 by allowing enough space for the roll to be inserted between the media support discs 63. An additional tension spring 73 may be used, so that both of the racks 65 are directly, and indirectly, biased together.

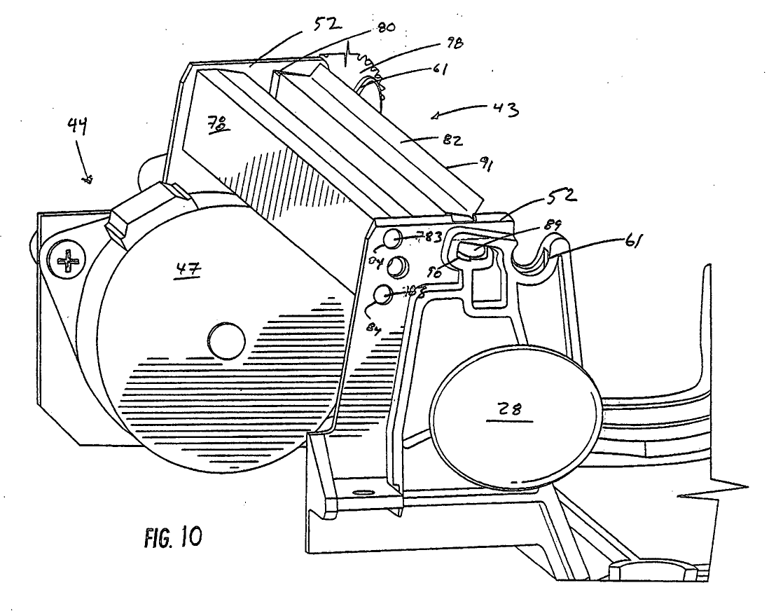

The print head assembly 43 includes a mounting bar 78, one or more springs 79, a heat sink 80, one or more stop screws, bolts or pegs 81, a tear bar 82 and a thermal printing interface 85, as shown in FIG. 5. The mounting bar 78 has an elongate rectangular shape and includes a pair of mounting pegs 83 on its ends. Cutouts in the mounting bar 78 reduce its weight and the elongate shape allows mounting of the mounting bar between the pair of side flanges 52. In particular, each of the side flanges 52 defines a pair of mounting openings 84 sized and positioned to receive the mounting pegs 83 on the ends of the mounting bar 78, as shown in FIG. 10.

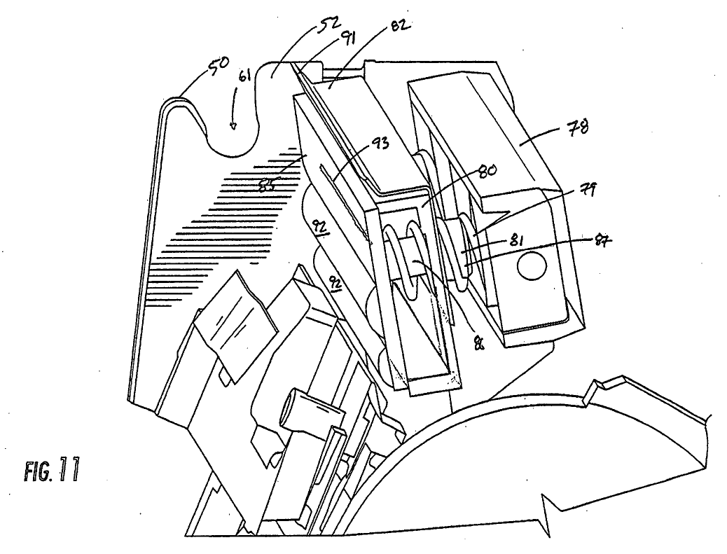

The springs 79 are attached at one end to the mounting bar 78 at spaced positions. The springs 79 are coil springs that extend toward the media support assembly 45, pass through openings in the heat sink 80 and attach at their other ends to the thermal printing interface 85. Extending within the springs 79 are the stop pegs 81, each of which includes a shaft 86 and a head 87. The shaft 86 of each of the stop pegs 81 attaches to the thermal printing interface 85 and extends through the heat sink 80 to the head 87. The head is positioned between the heat sink 80 and the mounting bar 78, as shown in FIG. 11.

Similar to the mounting bar 78, the heat sink 80 has an elongate rectangular shape that extends between the side flanges 52. Also, the heat sink 80 includes one of a pair of elliptical mounting pegs 89 at each of its ends. Defined in the side flanges 52 are slots 90 sized to receive a minor width of each of the elliptical mounting pegs 89. The length of the slots 90 allow sliding of the elliptical mounting pegs 89 therein. Attached to the heat sink 80 and extending therealong are the tear bar 82 and the thermal printing interface 85.

The tear bar 82 is constructed of a sheet of metal bent to conform to an upper corner of the heat sink 80, and includes a serrated tearing edge 91 flared upwards from the upper surface of the heat sink and over an upper edge of the thermal printing interface 85. The thermal printing interface 85 is attached to the heat sink 80 on the side of the media support assembly 45. On its outward surface facing the media support assembly, the thermal printing interface 85 includes a pair of arcuate rider surfaces 92 and a burn line 93. The rider surfaces 92 extend in parallel along the length of the thermal printing interface 85 below the burn line 93 which also extends along the length of the thermal printing interface.

A platen assembly 95 of the printer 10 is shown in FIGS. 5 and 6, and includes a platen bar 96, a platen shaft 97 and a platen gear 98 and is supported by a platen frame 99 of the media supply cover 15. In the illustrated embodiment, the platen bar 96 is an elongate, cylindrical bar that includes a rubber or polymeric coating to facilitate gripping of the strip of media 24. The platen bar 96 extends between a pair of spaced flanges 100 defined on opposite sides of the platen frame 99 near the wall structure 42 of the media supply cover 15. The platen shaft 97 extends from the ends of the platen bar 96 and through corresponding openings defined in the flanges 100 so as to rotatably support the platen bar and shaft. On one end, the platen shaft 97 supports the platen gear 98, which is recessed between the adjacent one of the flanges 100 and the wall structure 42, as shown in FIG. 6.

Preferably, the platen bar 96, platen shaft 97 and platen gear 98 are integrally constructed by being machined from a single piece of relatively rigid metal, such as steel or aluminum. Advantageously, integral construction ensures that the platen gear maintains its orientation during operation, even after the printer 10 has been jarred by a drop or other blow. In addition, use of metal allows the gear to withstand the heat of application of the rubber or polymeric coating on the outer surface of the platen bar 96.

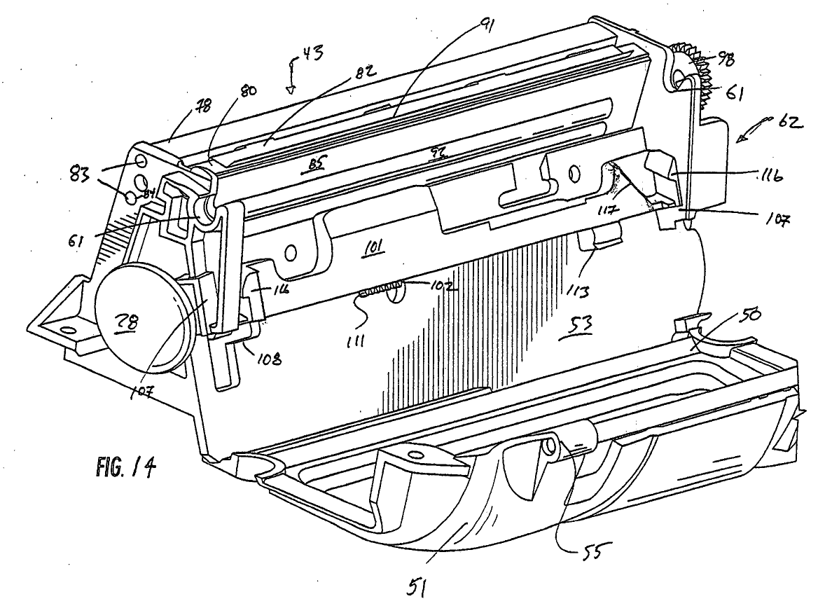

The side flanges 52 of the frame 50 define a pair of journal notches 61 that have a circular inner portion and a flared outer portion, as shown in FIGS. 11 and 14. The journal notches 61 are sized and shaped to receive ends of the platen shaft 97 when the media supply cover 15 is in a closed position.

When the media supply cover 15 is in the closed position, the platen assembly 95 cooperates with the drive assembly 44 and the media support assembly 45 to draw the strip of media 24 across the thermal printing interface 85 of the print head assembly 43 for printing. In particular, when the media supply cover 15 is closed, the platen bar 96 is positioned against the burn line 93 of the thermal printing interface 85 and the platen gear 98 meshes with the top-most one of the drive gears 48. The strip of media 24 extends over the rider surfaces 92 and between the platen bar 96 and the burn line 93. The thermal printing interface 85 is urged against the strip of media 24 and the platen bar 96 by the springs 79.

Advantageously, the thermal printing interface 85 can also shift to compensate for varying thicknesses of the strip of media 24 because of the elliptical mounting pegs 89 on the ends of the supporting heat sink 80 which can slide within the slots 90. This shifting motion is limited, or mediated, by the size of the slots 90 if the forces on the heat sink 80, tear bar 82 and thermal printing interface 85 are large, such as when the strip of media 24 is torn over the tear bar after printing. Optionally, the shifting motion may be limited also by the step pegs 81 dead-ending against the mounting bar 78. Engagement of the platen gear 98 with the drive gears 48 allows the motor 47 to turn the platen bar 96. The compression provided by the springs 79 and the friction of the gripping surface of the platen bar 96 enable the motion of the platen bar to pull the strip of media 24 off of the media supply roll 54.

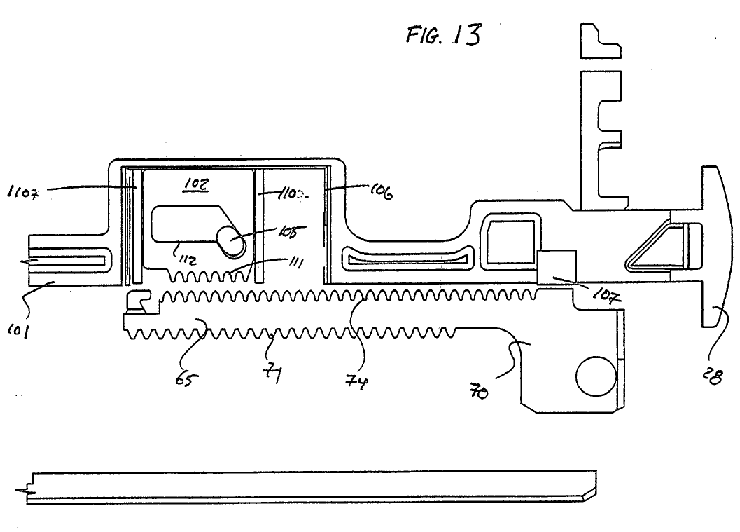

The latch assembly 62 includes a latch member 101, a locking plate 102 and a latch spring 103, as shown in FIG. 5. The latch member 101 has an elongate shape with the latch button 28 extending from one end. The latch member is slidably supported channels 107 that are defined in the side flanges 52 of the frame 50, as shown in FIGS. 13 and 14.

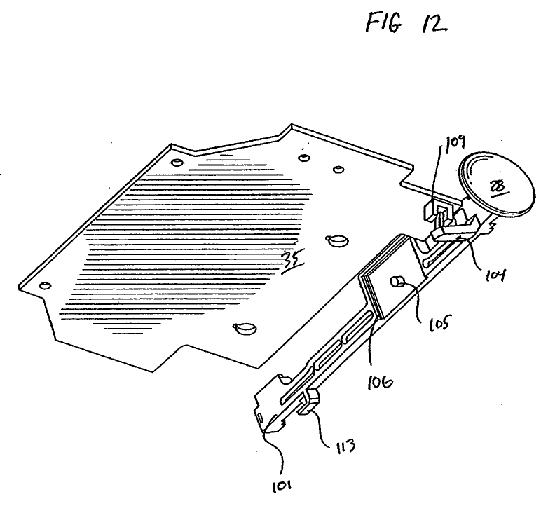

On a side of the latch member 101 facing the divider wall 53, the latch member includes a sensor arm 104 and a tracking peg 105 that is positioned in a rectangular recess 106, as shown in FIG. 12. The sensor arm 104 is positioned at one end of the latch member 101 and extends down through a sensor arm opening 108 defined in the divider wall 53 and upward into a U-shaped interrupt sensor 109. The U-shaped interrupt sensor is preferably an optical sensor that is supported by the main circuit board 35 and communicates interruption when the sensor arm is positioned in the arms of the sensor.

The rectangular recess 106 is sized to extend around a pair of vertically oriented locking plate guides 110 that extend outward from the divider wall 53, as shown in FIG. 5. The locking plate guides 110 are parallel and spaced apart from each other about the same distance as the width of the locking plate 102, as shown in FIG. 13. The locking plate 102 has a thin, rectangular shape and includes a row of teeth 111 extending along one edge. An engagement opening 112 defined in the locking plate includes an angled portion and a straight portion and is sized to extend around the tracking peg 105. The tracking peg extends outward from the base of the rectangular recess 106 and has an elongate shape with rounded ends that is sized to slide within the engagement opening 112.

As assembled, the latch member 101 extends closely along the divider wall 53 and the rectangular recess 106 is positioned over the locking plate guides 110. The locking plate 102 extends between the locking plate guides and the tracking peg 105 extends into the engagement opening 112. The shape of the engagement opening causes the teeth 111 of the locking plate 102 to be urged into and out of engagement with teeth on the locking face 74 of the adjacent rack arm 70. In particular, sliding of the latch member 101 (by depressing of latch button 28) moves the tracking peg 105 within the engagement opening 112 from the angled portion (as shown in FIG. 13) to the straight portion.

In the angled portion of the engagement opening, the locking plate 102 is positioned at the top of the locking plate guides 110 and adjacent the edge of the rectangular recess 106. In the straight portion, the locking plate is positioned at the bottom of the locking plate guides 110 and the teeth 111 of the locking plate 102 engage the teeth of the locking face 74. Notably, the teeth 111 of the locking plate 102 have a concavely curved shape so that they easily capture and urge themselves into firm engagement with the convexly curved shape of the teeth of the locking face, as shown in FIG. 8. It should be noted that the concavity and convexity of the teeth could be reversed and accomplish the same objective of a firm, positive fit.

Referring again to FIG. 12, the latch member 101 includes a spring flange 113 for engaging the latch spring 103. The latch spring is preferably a compression spring and is positioned between the spring flange 113 and the adjacent one of the side flanges 52 so that the latch member is biased to urge the button 28 outwards, i.e., in the left-handed direction on FIG. 5. Engagement of the latch member with the flanges 100 when the media supply cover is closed, as will be described in more detail below, holds the latch member short of its left-most position wherein the locking plate 102 is biased toward the engaged or locking position. In this position, the locking plate 102 inhibits movement of the racks 65 which, in turn, locks the media support discs 63 about the media supply roll 54. Opening of the lid 15 disengages the flanges 100 and the latch member 101, allowing the latch member to be biased to the outermost position, which disengages the locking plate 102 from the locking face 74.

Advantageously, engaging the rack arm 70 instead of engaging one of the pinions 72 allows for a compact locking mechanism because the rack arm can be locked external to the interface between the pinion face 71 and the pinions 72. Compactness of the locking mechanism is also derived from the positioning of the locking face 74 opposite the pinion face 71 and the recessed positioning of the locking plate 102 within the latch member 101. In addition, the direct engagement of the rack arm 70 by the locking plate 102 (as opposed to some type of engagement of one of the pinions 72) reduces complexity of the mechanism for robust performance.

It should be noted that the locking face 74 and the locking plate 102 could have interfaces other than teeth to allow for releasable engagement, such as adhesives, magnets or hook and loop connections. Also, it should be noted that the locking plate 102 could be positioned to engage a lateral, or other, surface of the of the rack arm 70. In addition, the locking plate 102 could engage the rack arm of the lower one of the racks 65. Further, the row of teeth 111 could be positioned on various shapes and sizes of members in lieu of the locking plate, that are cam activated by motion of the latch member 101, or even be supported directly on the latch member. For instance, the latch member may itself have cam surfaces so that it moves into and out of contact with the locking face 74 along with motion used to unlatch the media supply cover 15, and still be within the purview of the present invention.

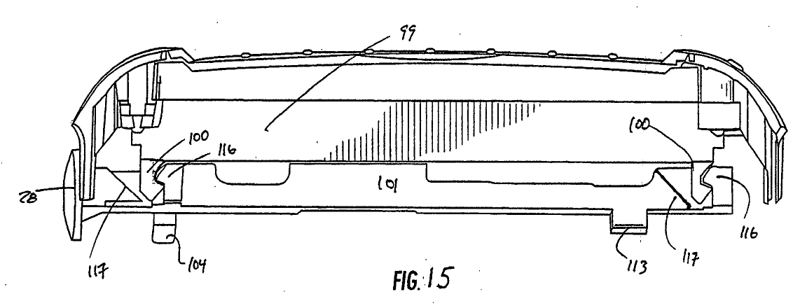

In addition to locking and unlocking the media support assembly 45, the latch assembly is configured to enable one-handed opening of the media supply cover 15. As shown in FIG. 15, the side of the latch member 101 facing the media support assembly 45 includes a pair of catch hooks 116 and a pair of outwardly sloped cam surfaces 117. The catch hooks 116 are configured to engage the similarly shaped flanges 100 on the platen frame 99 and, under the bias from the latch spring 103, hold the cover shut until the bias from the latch spring is overcome by depressing the latch button 28.

The outwardly sloped cam surfaces 117 are positioned to engage and urge the similarly sloped back sides of the flanges 100 on the platen frame 99 in an upward direction. Such urging helps to overcome bias against opening of the media supply cover 15, such as the weight of the platen assembly 95 and the media supply cover and friction between the biased thermal printing interface 85 and the rubber coated platen bar 96. In addition, the urging of the outwardly sloped cam surfaces 117 may be aided by the springs 79 of the print head assembly 43 urging the thermal printing interface 85 against the platen bar 96.

Opening is also inhibited somewhat by the shape of the journal notches 61 defined by the side flanges 52 of the frame 50. In particular, the intersection between the circular inner portion and flared outer portion of the journal notches 61 forms a shoulder that inhibits movement of the platen shaft 97 somewhat from the circular inner portion to the flared outer portion during opening of the media supply cover 15, as shown in FIG. 11. In addition, as the media supply cover 15 moves upwardly its motion is aided by the torsion spring 58 which has a sufficient bias to complete movement of the media supply cover into the open position after opening is initiated, as shown in FIGS. 2 and 6.

It should be noted that other shapes of cam surfaces 117 could be used to urge the media supply cover 15 upwards, and includes various surfaces with outwardly directed components. For instance, various sloped and curved shapes could be used in lieu of the linear ramp shape of the of the outwardly sloped cam surfaces 117 of the illustrated embodiment. As another alternative, the latch member 101 could be combined with other biasing devices that are activated after unlatching and provide an initial bias to the media supply cover 15. For instance, the latch member 101 could include its own compression spring that is released upon movement of the latch member to the unlatched position. Generally therefore, the present invention includes biasing of the media supply cover 15 combined with unlatching to facilitate one handed opening of the media supply cover.

During replacement of the media supply roll 54, the user pushes the latch button, 28 against the bias of the latch spring 103, which slides the latch member 101 inward and disengages the catch hooks 116 from the flanges 100 on the platen frame 99 supported by the media supply cover 15. At this point, the supply cover 15 is no longer locked down, but the torsion spring 58 provides insufficient bias to urge the media supply cover upwards against its own weight and the friction between the rubberized coating on the platen bar 96 and the thermal printing interface 85. At the same time, the tracking peg 105 is sliding along the straight portion of the engagement opening 112, as shown in FIG. 8.

After the catch hooks 116 have been disengaged, further compression of the latch button 28 engages the outwardly sloped cam surfaces 117 with the back sides of the flanges 100. As the flanges extend upward along the cam surfaces 117, the media supply cover 15 is urged upward, until the platen bar 96 is off of the thermal printing interface 85. Due at first to the bias of the torsion spring 58 and the bias from the cam surfaces 117, and eventually just the bias of the torsion spring when the media supply cover 15 has moved out of range of the latch member 101, the media supply cover 15 swings into the open position, as shown in FIG. 2.

At about the same time, the tracking peg 105 moves into the angled portion of the engagement opening 112 and urges the locking plate 102 upwards between the locking plate guides 110, thereby disengaging the locking plate teeth 111 from the teeth on the locking face 74 of the adjacent rack arm 70, as shown in FIG. 13. Disengagement of the teeth 74, 111 allows relative motion between the racks 65. The user can then reach in and retrieve the empty media supply roll 54. As the media supply roll is pulled the media support discs 63, disc support flanges 64 and the racks 65 are pushed apart against the bias exerted by the tension spring 73, allowing removal of the media supply roll with a single hand.

Placement of the new media supply roll 54 includes inserting the media supply roll between the media support discs 63 with one hand, pushing the media support discs apart against the tension spring 73. During insertion, the media support discs 63 remain centered (but could also right or left justify, or not justify at all, the media roll) due to the rotation of the pinions 72 which ensures coupling of the sliding motion of the racks 65. Once the ends of the media supply roll 54 are mounted within the edges of the media support discs 63, the user uses the same hand to push the media supply cover 15 closed against the bias of the torsion spring 58. Once the media supply cover 15 is nearly closed, the platen bar 96 pushes the thermal printing interface 85 back against the springs 79. As this occurs, the ends of the flanges 100 on the platen frame 99 intersect the tops of the catch hooks 116, sliding the latch member 101 against its bias from the latch spring 103 back into the configuration shown in FIG. 15.

Sliding of the latch member 101 also moves the tracking peg 105 from the angled portion of the engagement opening 112 in the locking plate 102, as shown in FIG. 13, into the straight portion of the engagement opening, as shown in FIG. 8. Movement into the straight portion causes the locking plate to slide within the locking plate guides 110 until the teeth 111 on the locking plate engage the teeth on the locking face 74 of the rack arm 70, thereby locking the racks 65 and the media support discs 63 in place.

The present invention has many advantages. The combined lid biasing and latching mechanism biasing allows for one-handed opening of the media supply cover 15 and replacement of the media supply. The initial bias of the latch member 101, the springs 79 of the print head assembly and the torsion spring 58 urge the media supply cover away from the rest of the housing 12 during an initial stage when the weight of the supply cover and platen assembly are at their largest. However, the initial bias from the print head springs and the latch member stop at a second stage so that only the torsion spring 58 smoothly, and relatively slowly, completes opening of the media supply cover door. Notably, therefore, the torsion spring 58 may be constructed of a relatively lightweight and inexpensive spring material that need not have a large spring constant. Use of a latching mechanism that locks the media supply in place when the media supply cover is closed ensures that the media will be secure. Securing the media by engaging the locking surface external to the opposing surfaces of the media support arms enables a more compact assembly, which is particularly useful for hand held printers. Use of multiple pinions between rack surfaces on the media support arms facilitates centering of newly placed media supply rolls.

In the preferred embodiment of the invention, as shown in FIG. 1, the display screen 32 is typically a liquid crystal display, as is familiar to those skilled in the art. In one embodiment of the invention, the display includes a series of associated buttons 33 that can be pressed to send information to the microprocessor shown in FIG. 3, which in turn can send data to the display. The microprocessor has a resident operating system capable of running algorithms that retrieve data, such as bitmaps, from EPROM, RAM, or other volatile or non-volatile memory. The microprocessor then provides data via well-established protocols, such as used with HT610 LCD driver, to the LCD driver for the purposes of printing such data in the display.

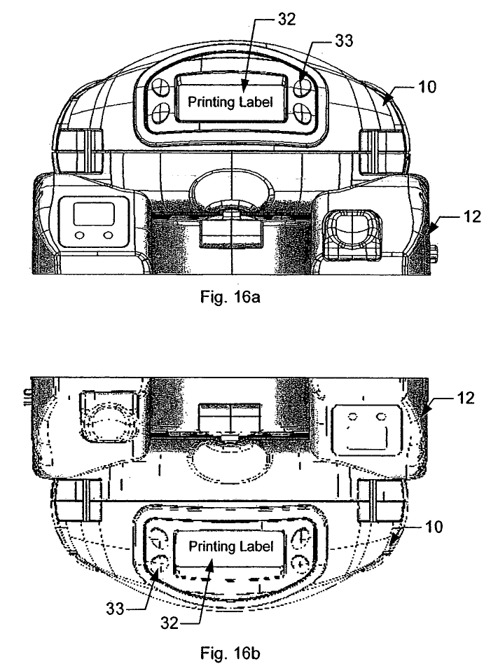

Importantly, the present invention provides systems and methods by which information displayed on the portable printer display can be provided in various orientations depending on user preference. For example, FIGS. 16a and 16b are respective illustrations of a portable printer in different mounting orientations. In FIG. 16a the portable printer is mounted in a first orientation typically considered to be right side up for the printer. FIG. 16b, on the other hand, illustrates a second orientation of the printer, where the printer is mounted in an upside orientation. FIG. 16a may represent an instance where the portable printer is mounted on the top of a shelf, such as car dashboard, while FIG. 16b represents an instance where the printer is mounted on the bottom of a shelf, such as the bottom of a car dashboard. As is illustrated, the systems and methods of the present invention allow text displayed on the portable printer to be properly oriented so that the text may be read regardless of the orientation of the printer.

It is noted here that FIGS. 16a and 16b only disclose a right side up and up side down orientation for the printer. These are not the only orientations that may be compensated for by the systems and methods of the claimed invention. The systems and methods may be used to orient the information displayed on the printer in any desired orientation.

Furthermore, the description below is given with respect to a particular LCD configuration having a specific number of display lines and number of characters per line. It must be understood that the systems and methods described herein and contemplated by the inventors is not limited to any one specific display type or configuration. The systems and methods may be used with any type of display that uses bit map or other form of picture display method, regardless of whether it is an LCD display, plasma display, LED display, etc.

In one embodiment of the invention, the systems and methods are implemented with a liquid crystal display that is made up of four lines with twenty characters per line. Stored in memory are bitmaps that correspond to each display character. In the bitmap for each character, there are six pixels in each column and eight pixels in each row. The process of writing a character to the display starts when the microprocessor—which in one embodiment can be a FH37727 processor manufactured by Renesas Technology Corp.—is activated, the bitmap for a character is retrieved, and the character is formed on the display. By manipulating the orientation in which the bitmap is displayed, the present invention can orient text printed on the display in any desired manner.

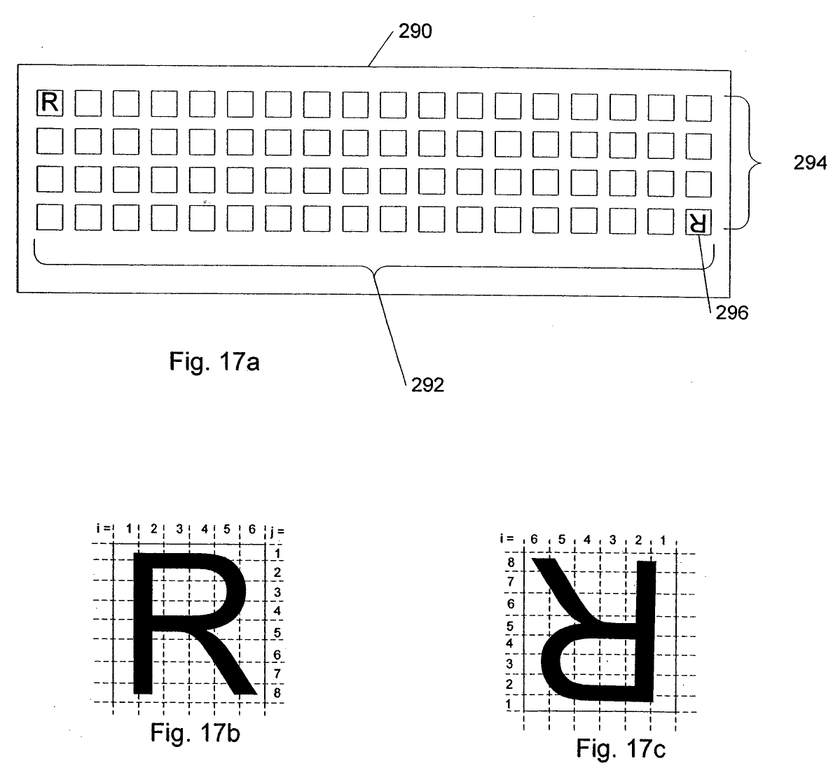

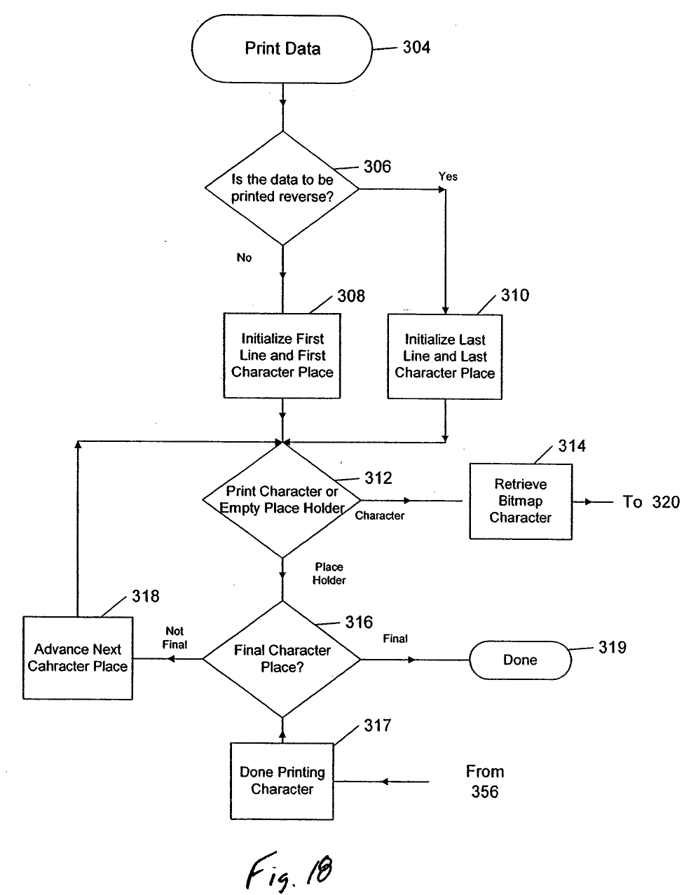

FIG. 17a illustrates a display according to one embodiment of the present invention. As illustrated, the display includes room from four lines, see label 294 of display with each line capable of display 20 characters, see label 292. As illustrated, the letter R is printed on line 1, character space 1 in an upright orientation. Further, the letter R is also printed on line 4, character space 20 in an upside down orientation. As illustrated, the systems and methods of the present invention are capable of oriented information on the display in any desired manner.

As a brief description, a bit map for each character that can be displayed is stored in memory. In the given example, each character consists of 48 pixels arranged in a matrix of 6 columns (i) and 8 rows (j). The proper pixels for displaying the character are typically colored differently from those pixels occupying background surrounding the character. In a general manner, to display the character, the processor for the LCD display starts with the first column and row and systematically displays each pixel for the first column. The processor then increments through each column 1-6 until the entire bit map is displayed. In this regard, the characters to be displayed are printed from top left to bottom right on the display in a conventional manner.

In contrast, if the print data is to be reoriented, the processor initializes the last character place 296 of the last line for printing. The processor then displays the character starting at the top left of the character place 296. However, as illustrated in FIG. 17c, because the bitmap it to be flipped, the processor begins with column 6 (i=6) instead of column 1. For each column, the processor retrieves the column of pixels from the bit map data and flips the data to reorient which pixels are colored to thereby display the character upside down. This is continued for each column until all columns are displayed.

The example of FIGS. 17a-17c illustrates reorientation of text in an upside down manner. It must be understood that this is only one example of the concepts embodied in the invention. These same concepts may be used to orient the characters in any manner.

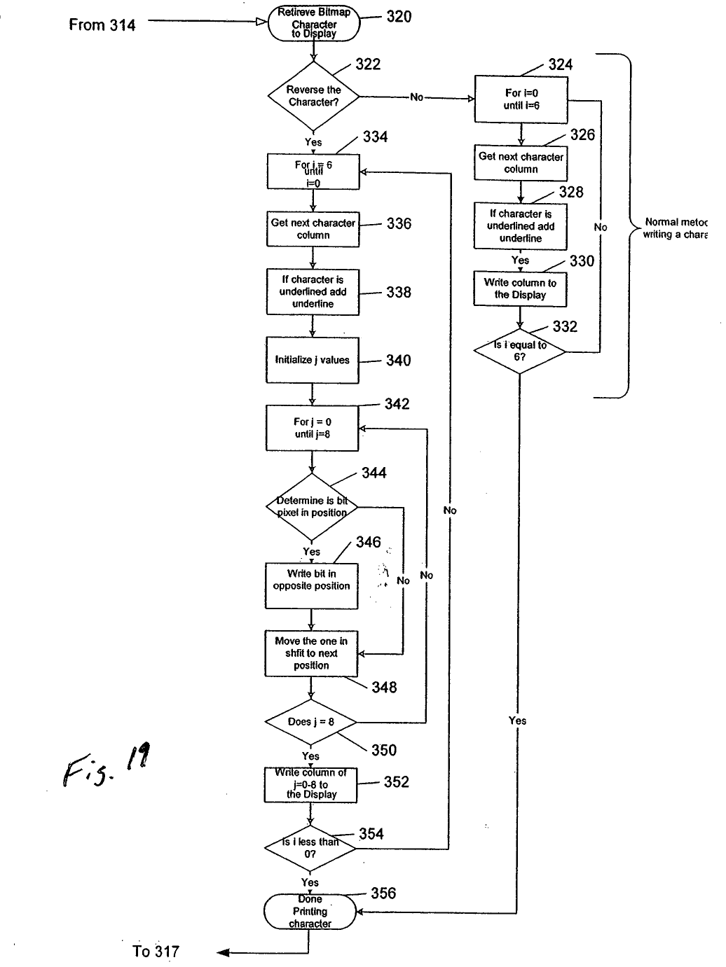

FIGS. 18 and 19 provide a flow diagram illustrating the display of characters in different orientations. Specifically, when information is to be printed on the display (see block 304), the bitmap is retrieved from either Read Only Memory (ROM) or Random Access Memory (RAM). The microprocessor will then determine whether the data needs to be printed in reverse. Block 306. If it does not need to be printed in reverse, the microprocessor initializes (see block 308) the first character place of the first line for printing. In this regard, the characters may be printed from top left to bottom right on the display in a conventional manner.

In contrast, if the print data is to be reoriented, the microprocessor initializes (see block 310) the last character place of the last line for printing, and the characters are printed from bottom left to top right. In this manner, the characters are reversed. The characters are also printed as a mirror image and flipped, as described below in conjunction with FIG. 19, which in combination with printing character places backwards permits a reversible image.

The microprocessor then determines (see block 312) whether the print data requires whether a character needs to be printed in a character place or if the place is to be left empty. If a character is to be printed, FIG. 19 illustrates the flow from block 314 (FIG. 18) to block 320 (FIG. 19) and the appropriate commands required to retrieve a bitmap character so that a character can be printed in that space. The microprocessor determines whether the final character place has been printed. Block 316. If not, it proceeds to the next character place (see block 318), thus repeating the preceding steps of determining whether a character or empty place holder is to be printed. When the final character place (either bottom right or top left, depending on whether the character needs to be reversed) is printed on the display, the process is complete. Block 317.

If the character needs to be reversed, as is the case when the printer is in “reverse” or “auto” mode, the processor accesses the last column of the bitmap, flips it, and writes it to the display in the first column of the display and then flips it. To reverse the display, the characters need to be written bottom right hand corner to the upper left hand corner on the display screen.

While all four rows and 20 columns of the display are described as being printed in one continuous flow of print data, this embodiment is for illustrative purposes only. For example, individual lines may be printed in reverse to the exclusion of other lines. Additionally, individual character spaces could be printed in reverse. Other characters or icons in the display may remain stationary. Those of ordinary skill in the art will recognize alternative print methods for printing reversible characters in accordance with the above processes without departing from the scope or spirit of the present invention.

FIG. 19 details the processes for printing an individual character in each character space. The microprocessor determines from the print data which character is to be printed. For example, if an “R” is to be printed, then the microprocessor retrieves (see block 320) an “R” bitmap from memory. The bitmaps, according to this embodiment and for example purposes, are i=6 columns by j=8 rows. The microprocessor determines whether the “R” is to be reversed. Block 322. This decision is the same decision that was made at block 306 in conjunction with FIG. 17. If the “R” does not need to be reversed, then a normal printing process, as illustrated in blocks 324-332.

The microprocessor prints column by column and retrieves the j=8 rows of pixels for a particular column. The process initializes at i=0, and then the microprocessor retrieves the next character column (see block 326), i=1. The microprocessor determines whether the character is to be underlined (see block 326) and prints an additional pixel under the character if it is to be underlined. The entire column where i=1 and j=1, 2, 3, 4, 5, 6, 7, 8 is written to the display via the display driver. See 330. If the final column of the character bitmap has not been written (see block 322), i.e. if i does not yet equal six, then the process is repeated for each column until i=6 and the character bitmap is fully displayed, and the character printing is complete. Block 356.

In more general terms, the microprocessor takes the first column and writes it to the display. The next column is accessed and written to the display column, and the process is repeated until all rows of the six columns have been written to the display. At this time, the bits of all 48 pixels should be written to the display, and the character should be present there. The process is repeated for each character in the display.

If the character is to be reversed, then the process is initializes (see block 334) at column i=6. The microprocessor retrieves the character column (see block 336), and determines whether it is to be underlined. If it is underlined, an additional pixel is printed underneath the character. Block 338. The microprocessor then initializes (see block 340) j values at j=0. The microprocessor determines (see block 344) whether there is a pixel in the position, and if there is, it writes 346 a bit in the corresponding opposite (flipped) position. If there is not a bit pixel in that position, the microprocessor shifts (see block 348) to the next j position, j=2. Since j does not equal 8 (see block 350), the process outlined in blocks 344-348 is repeated. Once j=8, the column of j=0-8 is written (see block 352) to the Display. If i is still greater than 0, the process starting with block 334 is repeated. Once i is less than 0, the microprocessor is done printing the character. Block 356.

As a further understanding of the invention, the system may display a character on a display in pixel array having columns x=1 to x=n and rows y=1 to y=n. In this instance, one or more of the characters is stored in the memory device as a bitmap having an array of pixels, where the array is formed of columns i=1 to i=n and rows j=1 to j=n, such that a pixel is located within a cell at each column-row location. To display a character in a first orientation, the system begins at x=1, y=1 of the pixel array of the display and displays the pixel located at i=1, j=1 of the bit map and displays each pixel of each row of column i=1 from row j=1 to j=n at respective rows of column x=1 of the pixel array of the display. The system then repeats for each subsequent column i=2 to i=n of the pixel array of the bitmap for each respective column x=2 to x=n of the pixel array of said display.

To display the character in a second orientation, the system begins at x=1, y=1 of the pixel array of the display and displays the pixel located at i=n, j=n of the bit map and displays each pixel of each row of column i=n from row j=n-1 to j=1 at respective rows of column x=1 of the pixel array of the display. The system then repeats for each subsequent column i=n-1 to i=1 of the pixel array of the bitmap for each respective column x=2 to x=n of the pixel array of the display.

As an alternative method, the system could store different bit map orientations for each letter. In this embodiment, the system determines the orientation of the display and selects the appropriate bit map orientation for displaying the letters.

In typical embodiments, the selection of the orientation of the display may be made by a user via button selection. However, other methods are contemplated. For example, as shown in FIG. 1, the portable printer is located in the cradle. The cradle may include an electrical connector that provides a command concerning display orientation. Further, the printer could include an internal orientation sensor, such as a gyroscope switch, mercury switch, etc. that senses the orientation of the printer and configures the display appropriately.

Many modifications and other embodiments of the inventions set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A printer capable of altering the orientation of information displayed on an associated printer display, said portable printer comprising:
a display;
a memory device comprising characters to be displayed; and
a processor in communication with said memory device and said display, wherein said processor manipulates one or more of the characters so as to display the one or more characters in one of at least two different orientations on the display.

2. A printer according to claim 1, wherein said memory device comprises characters stored therein, wherein one or more of the characters is stored as a bitmap having an array of pixels, and wherein said processor manipulates the pixels of the bitmap so as to display the one or more characters in one of at least two orientations on the display.

3. A printer according to claim 1, wherein one or more of the characters is stored in said memory as a bitmap having an array of pixels, wherein the array of pixels is formed of columns i=1 to n and rows j=1 to n, such that a pixel is located within a cell at each column-row location, wherein to display a character in a first orientation, said processor begins at column i=1 of the array and displays each pixel located in rows from j=1 to j=n in column i=1 and repeats for each subsequent column i=2 to i=n.

4. A printer according to claim 1, wherein one or more of the characters is stored in said memory as a bitmap having an array of pixels, wherein the array of pixels is formed of columns i=1 to n and rows j=1 to n, such that a pixel is located within a cell at each column-row location, wherein to display a character in a second orientation, said processor begins with the last column i=n of the array of pixels of the bitmap, and displays the pixels located in rows from j=n to j=1 in column i=n and repeats for each subsequent column i=n-1 to i=1.

5. A printer according to claim 1, wherein said processor displays a character on a display in pixel array having columns x=1 to x=n and rows y=1 to y=n, wherein one or more of the characters is stored in said memory device as a bitmap having an array of pixels, wherein the array is formed of columns i=1 to i=n and rows j=1 to j=n, such that a pixel is located within a cell at each column-row location, wherein to display a character in a first orientation, said processor begins at x=1, y=1 of the pixel array of said display and displays the pixel located at i=1, j=1 of the bit map and displays each pixel of each row of column i=1 from row j=1 to j=n at respective rows of column x=1 of the pixel array of said display and repeats for each subsequent column i=2 to i=n of the pixel array of the bitmap for each respective column x=2 to x=n of the pixel array of said display.

6. A printer according to claim 1, wherein said processor displays a character on a display in pixel array having columns x=1 to x=n and rows y=1 to y=n, wherein one or more of the characters is stored in said memory device as a bitmap having an array of pixels, wherein the array is formed of columns i=1 to i=n and rows j=1 to j=n, such that a pixel is located within a cell at each column-row location, wherein to display a character in a second orientation, said processor begins at x=1, y=1 of the pixel array of said display and displays the pixel located at i=n, j=n of the bit map and displays each pixel of each row of column i=n from row j=n-1 to j=1 at respective rows of column x=1 of the pixel array of said display and repeats for each subsequent column i=n-1 to i=1 of the pixel array of the bitmap for each respective column x=2 to x=n of the pixel array of said display.

7. A method of altering the orientation of information displayed on a printer display comprising:
providing a memory device comprising characters to be displayed; and
displaying the one or more characters in one of the at least two orientations.

8. A method according to claim 7, wherein said providing step provides a memory device comprising characters stored therein, wherein one or more of the characters is stored as a bitmap having an array of pixels, and wherein said displaying step manipulates the pixels of the bitmap so as to display the one or more characters in one of at least two orientations on the display.

9. A method according to claim 7, wherein one or more of the characters is stored in the memory device as a bitmap having an array of pixels, wherein the array of pixels is formed of columns i=1 to n and rows j=1 to n, such that a pixel is located within a cell at each column-row location, wherein to display a character in a first orientation, said displaying step begins at column i=1 of the array and displays each pixel located in rows from j=1 to j=n in column i=1 and repeats for each subsequent column i=2 to i=n.

10. A method according to claim 7, wherein one or more of the characters is stored in the memory device as a bitmap having an array of pixels, wherein the array of pixels is formed of columns i=1 to n and rows j=1 to n, such that a pixel is located within a cell at each column-row location, wherein to display a character in a second orientation, said displaying step begin with the last column i=n of the array of pixels of the bitmap, and displays the pixels located in rows from j=n to j=1 in column i=n and repeats for each subsequent column i=n-1 to i=1.

11. A method according to claim 7, wherein said displaying step displays a character on a display in pixel array having columns x=1 to x=n and rows y=1 to y=n, wherein one or more of the characters is stored in the memory device as a bitmap having an array of pixels, wherein the array is formed of columns i=1 to i=n and rows j=1 to j=n, such that a pixel is located within a cell at each column-row location, wherein to display a character in a first orientation, said displaying step begins at x=1, y=1 of the pixel array of said display and displays the pixel located at i=1, j=1 of the bit map and display each pixel of each row of column i=1 from row j=1 to j=n at respective rows of column x=1 of the pixel array of the display and repeats for each subsequent column i=2 to i=n of the pixel array of the bitmap for each respective column x=2 to x=n of the pixel array of the display.

12. A method according to claim 7, wherein said displaying step displays a character on a display in pixel array having columns x=1 to x=n and rows y=1 to y=n, wherein one or more of the characters is stored in the memory device as a bitmap having an array of pixels, wherein the array is formed of columns i=1 to i=n and rows j=1 to j=n, such that a pixel is located within a cell at each column-row location, wherein to display a character in a second orientation, said displaying step begins at x=1, y=1 of the pixel array of the display and displays the pixel located at i=n, j=n of the bit map and display each pixel of each row of column i=n from row j=n-1 to j=1 at respective rows of column x=1 of the pixel array of the display and repeats for each subsequent column i=n-1 to i=1 of the pixel array of the bitmap for each respective column x=2 to x=n of the pixel array of the display.

13. A printer capable of altering the orientation of information displayed on an associated printer display, said portable printer comprising:
a display;
a memory device comprising characters to be displayed, wherein one or more of the characters is stored in said memory as a bitmap having an array of pixels, wherein the array of pixels is formed of columns i=1 to n and rows j=1 to n, such that a pixel is located within a cell at each column-row location; and
a processor in communication with said memory device and said display, wherein said processor displays a character on said display in pixel array having columns x=1 to x=n and rows y=1 to y=n, wherein to display a character in a one orientation, said processor begins at x=1, y=1 of the pixel array of said display and displays the pixel located at i=n, j=n of the bit map and displays each pixel of each row of column i=n from row j=n-1 to j=1 at respective rows of column x=1 of the pixel array of said display and repeats for each subsequent column i=n-1 to i=1 of the pixel array of the bitmap for each respective column x=2 to x=n of the pixel array of said display.

14. A method of altering the orientation of information displayed on an associated display comprising:
providing a display;
providing a memory device comprising characters to be displayed, wherein one or more of the characters is stored in said memory as a bitmap having an array of pixels, wherein the array of pixels is formed of columns i=1 to n and rows j=1 to n, such that a pixel is located within a cell at each column-row location; and
displaying a character on the display in a pixel array having columns x=1 to x=n and rows y=1 to y=n, wherein to display a character in a one orientation, said displaying step begins at x=1, y=1 of the pixel array of the display and displays the pixel located at i=n, j=n of the bit map and displays each pixel of each row of column i=n from row j=n-1 to j=1 at respective rows of column x=1 of the pixel array of said display and repeats for each subsequent column i=n-1 to i=1 of the pixel array of the bitmap for each respective column x=2 to x=n of the pixel array of the display.
